(19) United States
(12) Patent Application Publication
(10) Pub. No.: US 2024/0251715 A1
(43) Pub. Date: Aug. 1, 2024

(54) BERRY HARVESTING MECHANISM

(71) Applicant: MICHIGAN BLUEBERRY GROWERS ASSOCIATION, GRAND JUNCTION, MI (US)

(72) Inventor: Jeffrey David McKibben, Grand Junction, MI (US)

(73) Assignee: MICHIGAN BLUEBERRY GROWERS ASSOCIATION, GRAND JUNCTION, MI (US)

(21) Appl. No.: 18/405,211

(22) Filed: Jan. 5, 2024

Related U.S. Application Data
(60) Provisional application No. 63/441,471, filed on Jan. 27, 2023.

(51) Int. Cl. A01D 46/26; A01D 69/00

(52) U.S. Cl. CPC A01D 46/264; A01D 69/00

(57) ABSTRACT

A berry harvesting assembly includes a first shaker assembly that is rotatably driven by a first drive shaft and a second shaker assembly that is rotatably driven by a second drive shaft. The first shaker assembly and the second shaker assembly define a picking pathway therebetween. Each shaker assembly includes a plurality of vertically-aligned sub-assemblies. Each sub-assembly of the plurality of vertically-aligned sub-assemblies is configured to rotate independently from one another about a respective drive shaft of the first drive shaft and the second drive shafter. Each shaker assembly further includes a counterweight assembly that is operably coupled to the respective drive shaft to provide an adjustable vibration frequency across the plurality of vertically-aligned sub-assemblies. The adjustable vibration frequency is applied independent of a rotational speed of the plurality of vertically-aligned sub-assemblies.

### CROSS-REFERENCE TO RELATED APPLICATION

This application claims priority to and the benefit under 35 U.S.C. § 119(e) of U.S. Provisional Patent Application No. 63/441,471, filed on Jan. 27, 2023, entitled BERRY HARVESTING MECHANISM, the entire disclosure of which is hereby incorporated herein by reference.

### FIELD OF THE DISCLOSURE

The present disclosure generally relates to a berry harvesting mechanism. More specifically, the present disclosure relates to a berry harvesting assembly that includes shaker assemblies having a plurality of vertically-aligned sub-assemblies.

### BACKGROUND OF THE DISCLOSURE

Blueberries and other similar berry varieties (e.g., raspberries, blackberries, red or black currants) can be harvested and sold as fresh produce or processed for freezing. Traditionally, hand-picking blueberries has been the most valued method to retain high-quality blueberries (e.g., minimal bruising and splitting) at the desired ripeness. Mechanical picking, or mechanical harvesting using conventional sway or conventional rotary machines are often too rough on the bush, which can cause undue bruising to the fruit and also tends to remove a disproportionate amount of berries that are green and not yet ripe. Likewise, conventional machines tend to leave blue, or ripe berries on the bush, which leaves behind potential revenue and creates issues with picking “mush” during a subsequent harvesting. Rough impact to the blueberry bushes can cause lateral branches to break and negatively affect the health of the bush and, therefore, the capacity of the bush to grow future berries.

### SUMMARY

According to an aspect of the present disclosure, a berry harvesting assembly includes a first shaker assembly that is rotatably driven by a first drive shaft and a second shaker assembly that is rotatably driven by a second drive shaft. The first shaker assembly and the second shaker assembly define a picking pathway therebetween. Each shaker assembly includes a plurality of vertically-aligned sub-assemblies. Each sub-assembly of the plurality of vertically-aligned sub-assemblies is configured to rotate independently from one another about a respective drive shaft of the first drive shaft and the second drive shafter. Each shaker assembly further includes a counterweight assembly that is operably coupled to the respective drive shaft to provide an adjustable vibration frequency across the plurality of vertically-aligned sub-assemblies. The adjustable vibration frequency is applied independent of a rotational speed of the plurality of vertically-aligned sub-assemblies.

According to another aspect of the present disclosure, a produce harvesting assembly includes a first shaker assembly that is rotatably driven by a first drive shaft and a second shaker assembly that is rotatably driven by a second drive shaft. The first shaker assembly and the second shaker assembly define a harvesting pathway therebetween. A plurality of vertically-aligned sub-assemblies respectively are positioned for rotational operation about the first and second drive shaft. Each sub-assembly of the plurality of vertically-aligned sub-assemblies include a frame that is positioned for rotational operation about a respective drive shaft of the first and second drive shaft, a plurality of harvesting fingers that extend from the frame, a speed limiter that selectively operates relative to the frame to slow rotation of the frame relative to a rotational speed of the respective drive shaft, and a counterweight assembly that is operably attached to the respective drive shaft and is rotationally operable according to the rotational speed of the respective drive shaft. The respective drive shaft and the counterweight assembly operate to produce a selected vibration frequency of the first and second shaker assemblies.

According to yet another aspect of the present disclosure, a produce harvesting assembly includes a first shaker assembly that rotationally operates about a first rotational axis, a second shaker assembly that rotationally operates about a second rotational axis, the first and second shaker assemblies define a processing area therebetween, a drive assembly that rotationally operates the first and second shaker assemblies about the first and second rotational axes, respectively, and a plurality of rotating sub-assemblies that are rotationally coupled to the drive assembly. Each rotating sub-assembly of the plurality of rotating sub-assemblies are rotationally operable about the first rotational axis and the second rotational axis, respectively. Each rotating sub-assembly includes a frame, a plurality of harvesting fingers that extend from the frame, a speed limiter that selectively operates to slow a rotation of the frame relative to a drive speed of the drive assembly, and a pair of counterweights that are operably attached to the drive assembly and rotationally operate according to the drive speed of the drive assembly and independent of the rotation of the frame. The drive assembly and the pair of counterweights operate to produce a selected vibration frequency.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of a berry picking machine that incorporates an aspect of the harvesting mechanism;

FIG. 2 is a perspective view of a berry picking machine that incorporates an aspect of the harvesting mechanism;

FIG. 3 is a perspective view of the harvesting mechanism that is incorporated within the berry picking machine;

FIG. 4 is an enlarged perspective view of a picking sub-assembly of the harvesting mechanism and shown incorporated within the shaker assembly of the harvesting mechanism;

FIG. 5 is an enlarged perspective view of a picking sub-assembly of the harvesting mechanism and shown incorporated within the shaker assembly of the harvesting mechanism;

FIG. 6 is a top perspective view of an aspect of the shaker assembly and showing interaction with a berry bush and guides that direct the berry bush through the picking pathway of the berry picking machine;

FIG. 7 is a side perspective view of an aspect of the tensioning mechanism that adjusts the friction applied to each of the sub-assemblies of the harvesting mechanism;

FIGS. 8A and 8B are perspective views of exemplary controls for operating the harvesting mechanism;

FIGS. 9A and 9B are perspective views of the harvesting mechanism and showing interaction of the first and second shaker assemblies within the picking pathway of the berry picking machine;

FIGS. 10A and 10B are perspective views of the harvesting mechanism and showing interaction of the first and second shaker assemblies within the picking pathway of the berry picking machine;

FIGS. 11A and 11B are perspective views of the harvesting mechanism and showing interaction of the first and second shaker assemblies within the picking pathway of the berry picking machine;

FIG. 12 is a schematic diagram illustrating operation of a shaker assembly that incorporates a frame that is selectively adjusted to vary the speed at which the frame rotates and a counterweight assembly that consistently rotates according to a set speed of a motor that drives the harvesting mechanism;

FIG. 13 is an enlarged perspective view of a sub-assembly for the harvesting mechanism and showing interaction of the frame and the counterweight assembly with a drive shaft of the harvesting mechanism; and

FIG. 14 is a linear flow diagram illustrating a method for operating a berry picking mechanism.

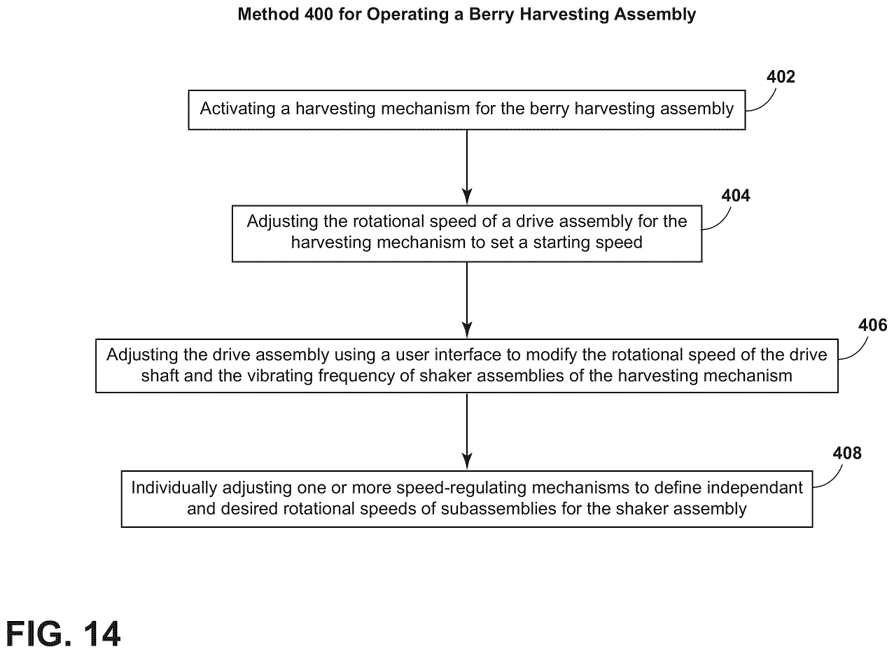

### DETAILED DESCRIPTION

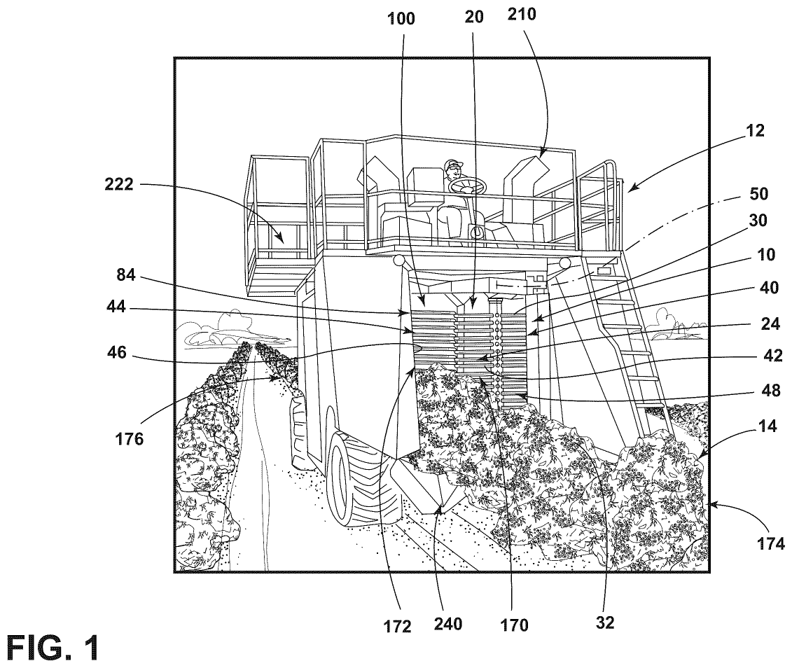

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a harvesting mechanism for a berry picking machine that incorporates a plurality of vertically operable sub-assemblies that include a shaking mechanism, where a rotational speed of the sub-assemblies can be adjusted relative to the rotational operation of the drive shaft and the rotational speed of the shaker assembly remains consistent with respect to the drive shaft of the harvesting mechanism. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

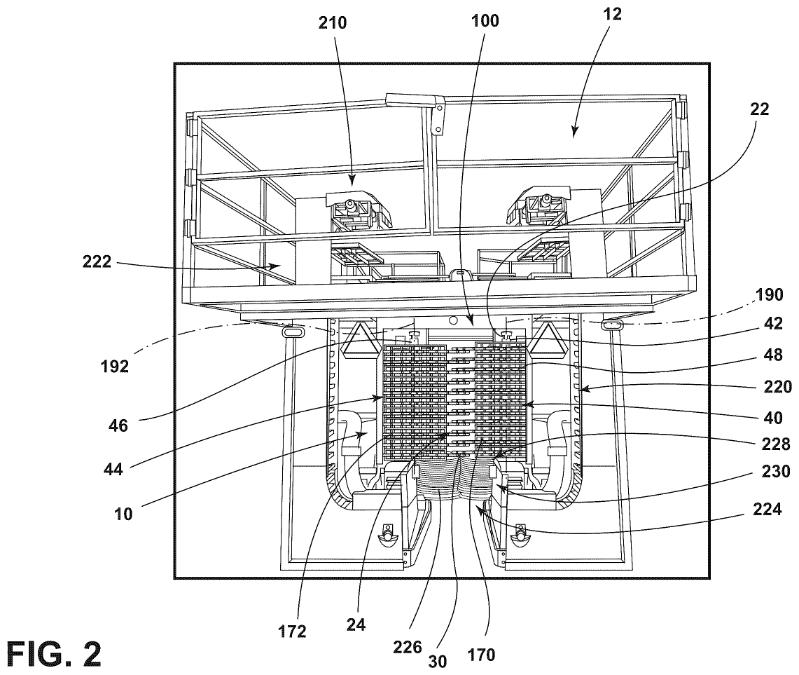

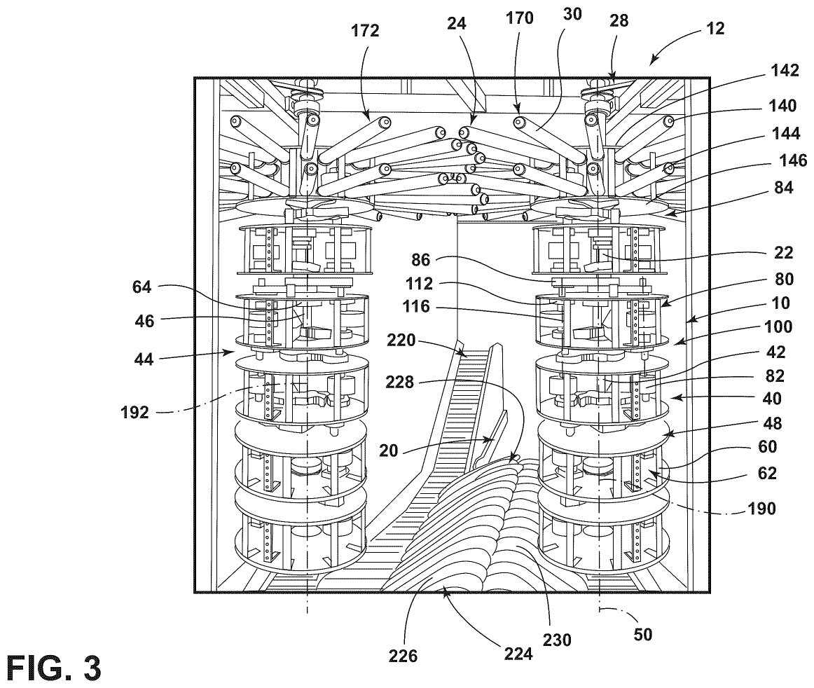

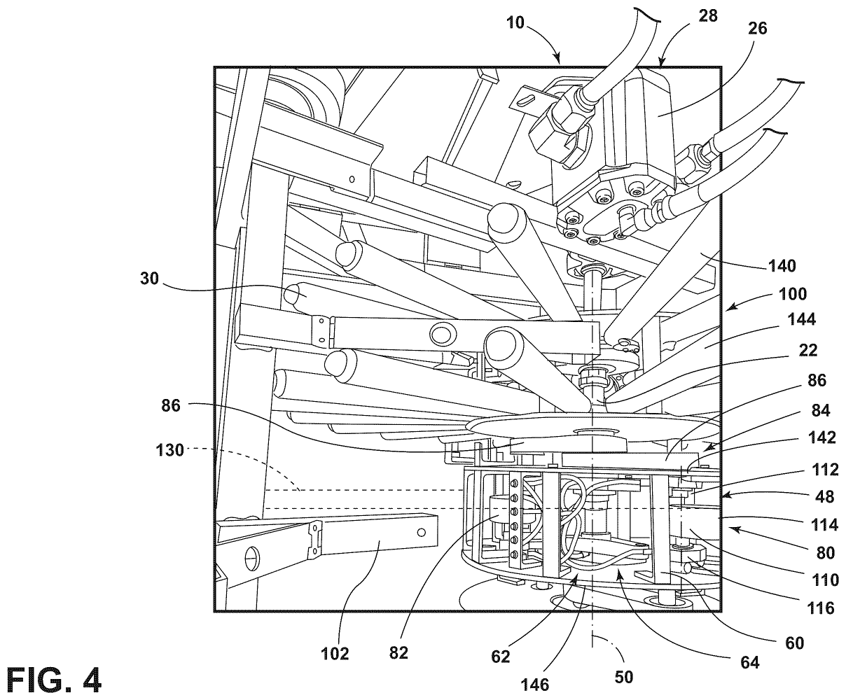

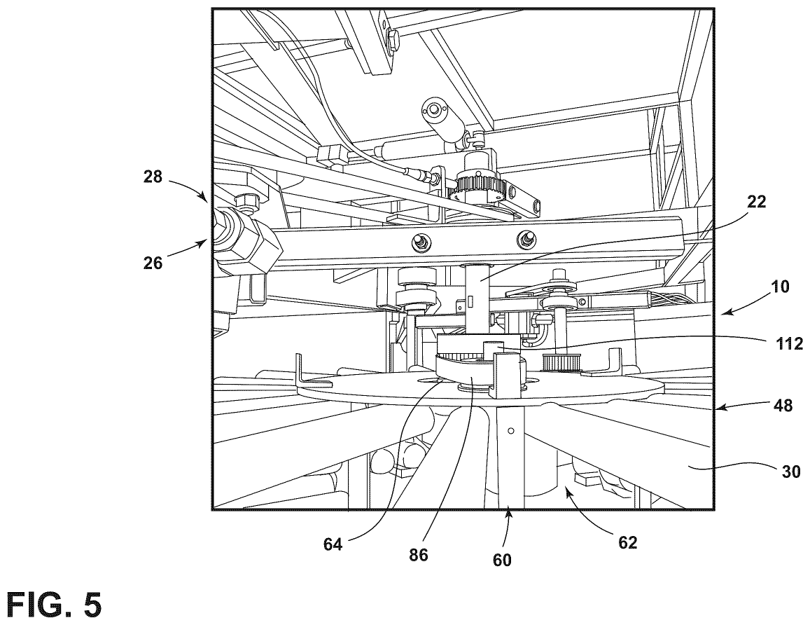

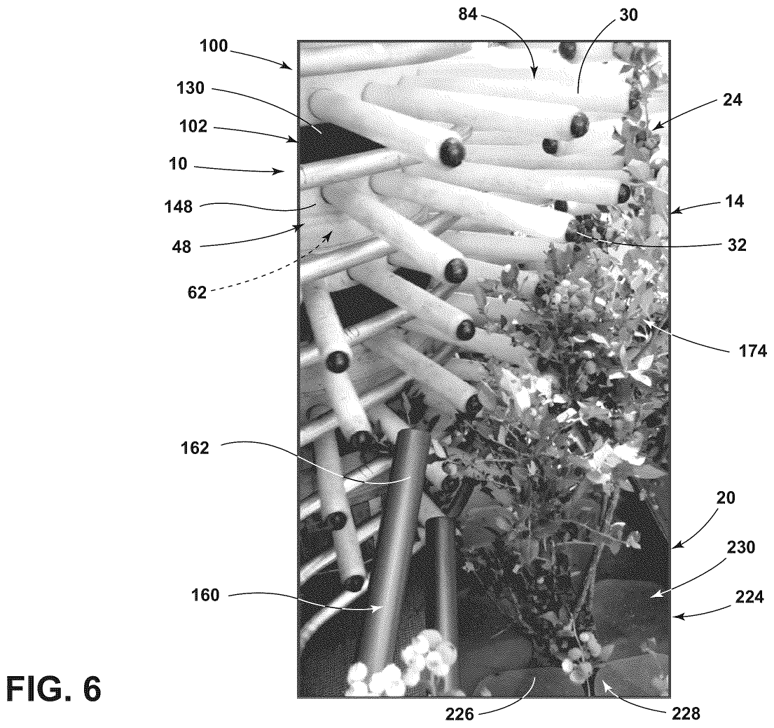

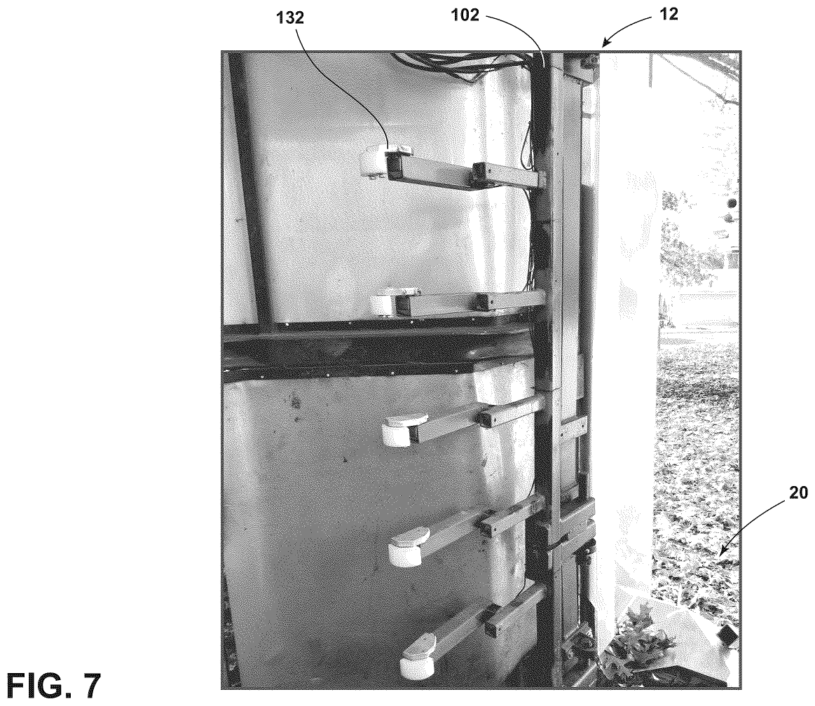

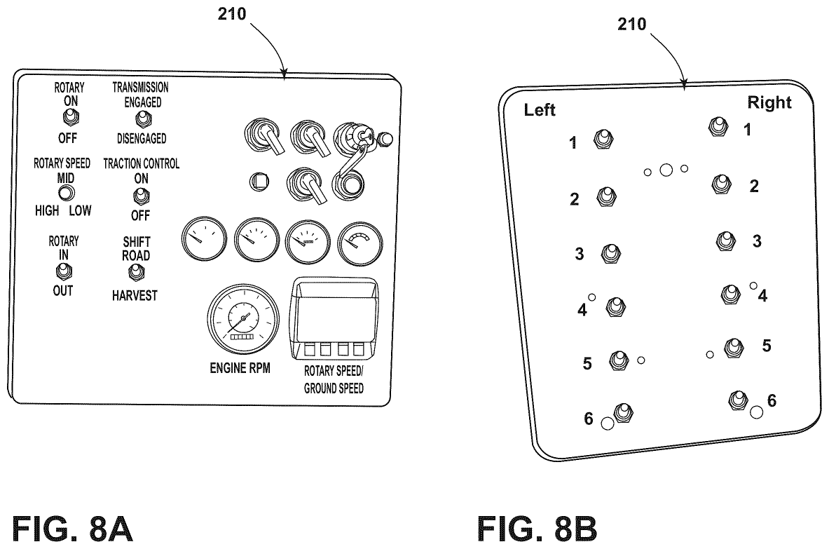

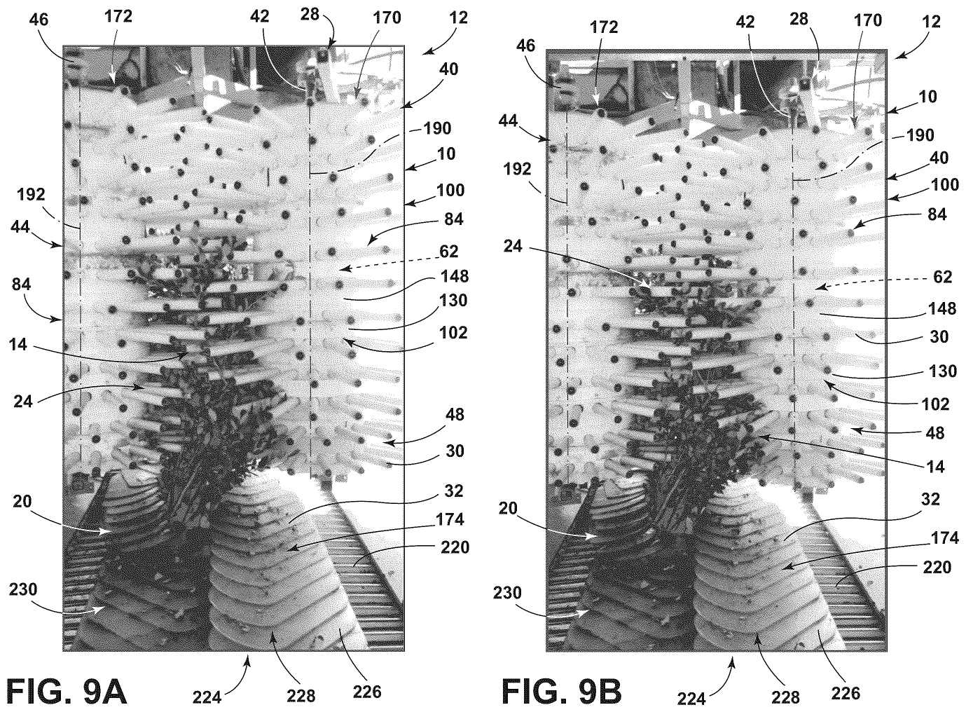

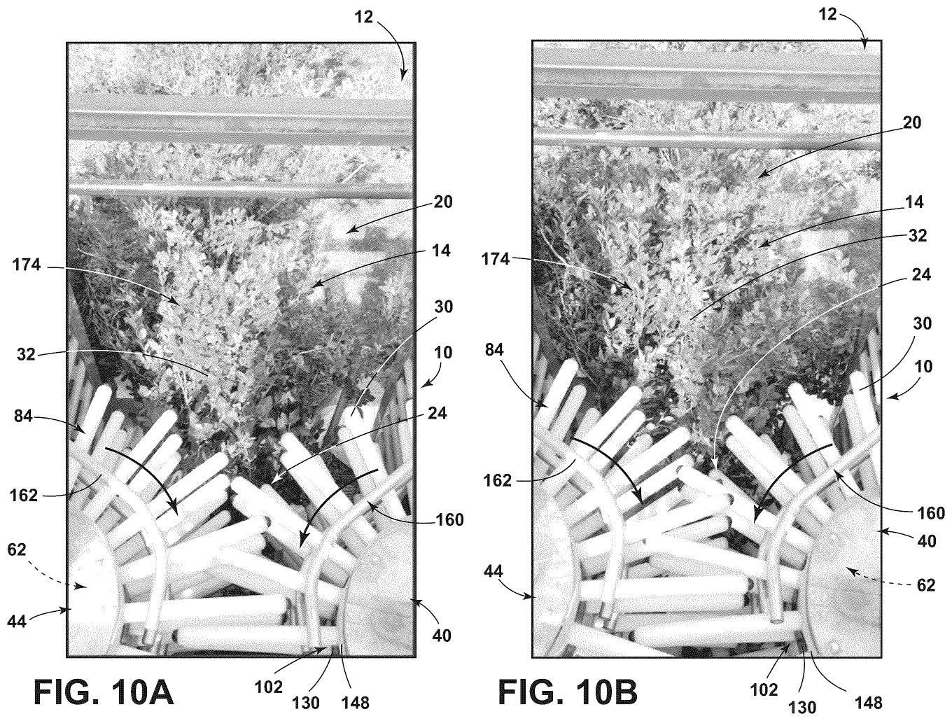

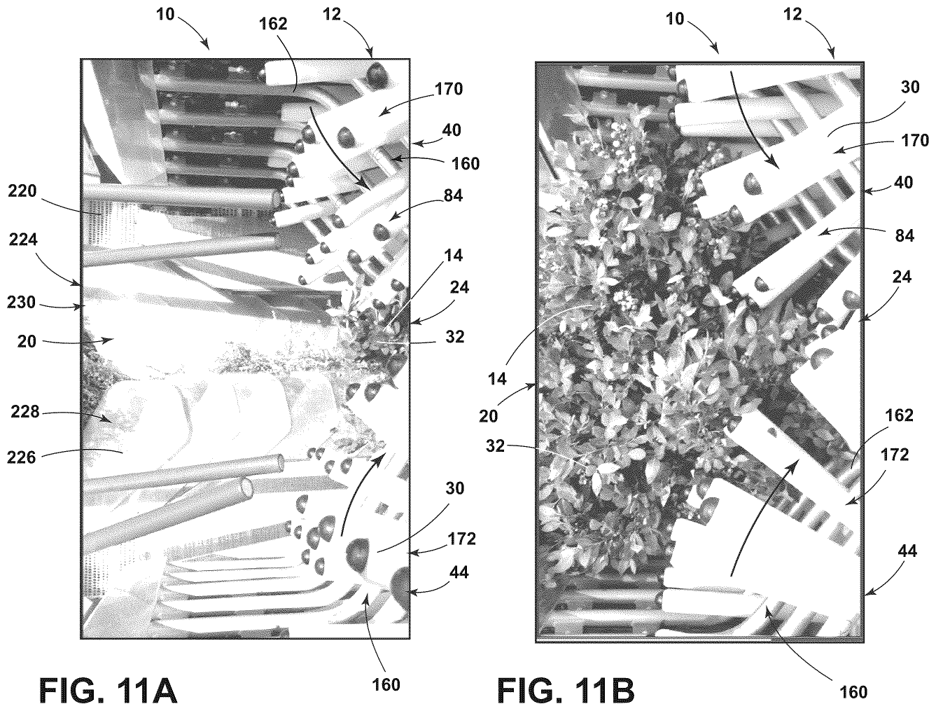

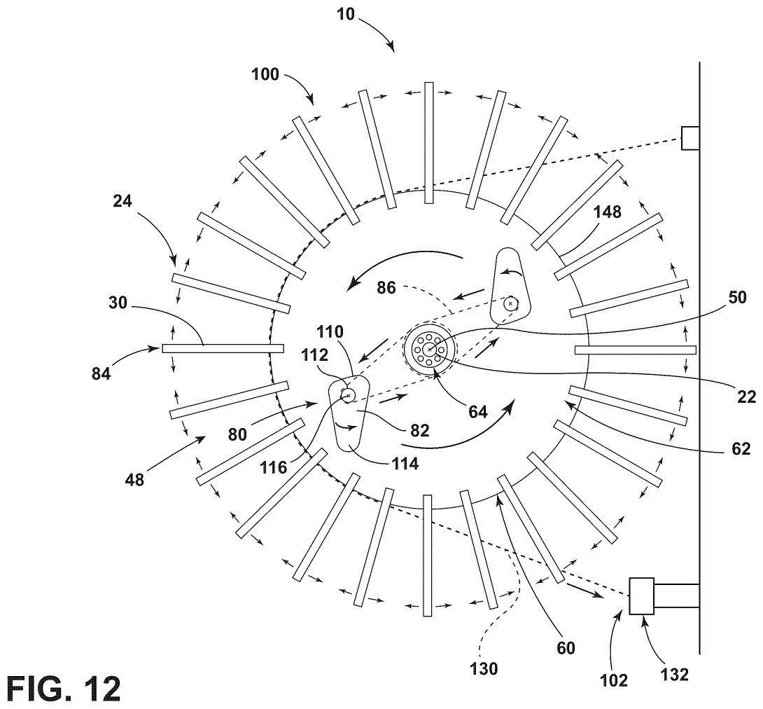

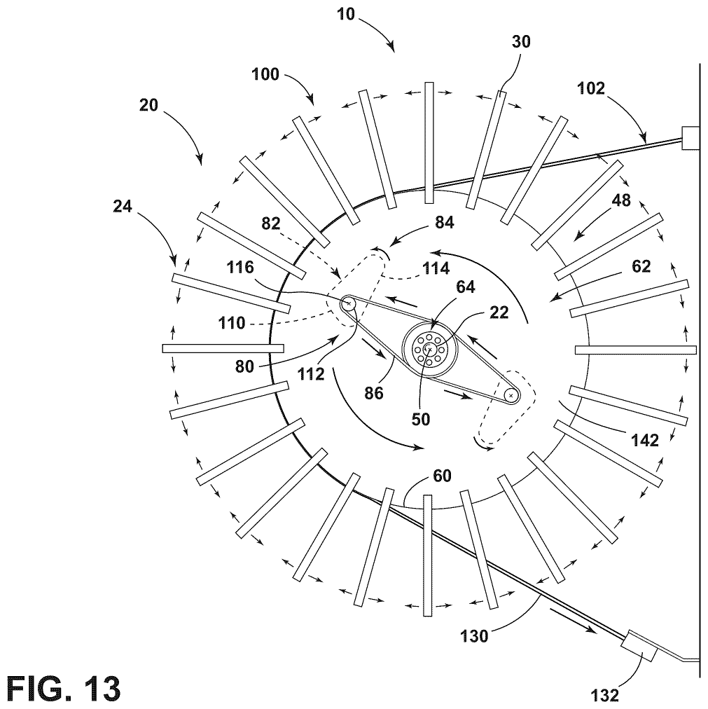

According to the various aspects of the device as illustrated in FIGS. 1-13, reference numeral 10 generally refers to a harvesting mechanism that is incorporated within a berry harvesting assembly 12. The berry harvesting assembly 12 can be a self-contained vehicle that includes a drive system for operating the berry picking assembly relative to berry bushes and other vegetation 14 for harvesting produce 174. The berry harvesting assembly 12 can also be a trailer or rig that is towed behind a separate vehicle for conducting various harvesting operations, as described herein.

Referring again to FIGS. 1-13, the harvesting mechanism 10 rotationally operates within a harvesting pathway, also referred to as a picking pathway 20, of the berry harvesting assembly 12. The picking pathway 20 is a generally linear path through which vegetation 14, such as plants, bushes, shrubs, and other harvestable vegetation 14 passes for being acted upon by the harvesting mechanism 10. The harvesting mechanism 10 includes opposing drive shafts 22 that are positioned within a harvesting zone 24 of the berry harvesting assembly 12. The harvesting zone 24 is a location within the berry harvesting assembly 12 where the harvesting mechanism 10 intersects with the picking pathway 20. The opposing drive shafts 22 rotationally operate according to the operation of a single motor 26 or dedicated motors 26 that form a drive assembly 28 of the harvesting mechanism 10. The drive assembly 28 rotates the drive shafts 22 at a desired speed that can be in a range of approximately 600 rpm to approximately 2400 rpm, and various rotational speeds therebetween. As the drive shafts 22 rotate relative to the picking pathway 20, various shaker rods 30 extend from the harvesting mechanism 10 for acting upon the vegetation 14 moving through the picking pathway 20 for releasing ripened berries 32 to be harvested from the vegetation 14. As discussed more fully herein, the harvesting mechanism 10 operates to harvest ripened berries 32 and leaving un-ripened berries 32 on the vegetation 14. In this manner, the un-ripened berries 32 are allowed to mature into ripened berries 32 for harvesting at a later time.

Referring again to FIGS. 1-13, the harvesting mechanism 10 for the berry harvesting assembly 12 includes a first shaker assembly 40 that is rotationally driven by a first drive shaft 42. A second shaker assembly 44 is rotationally driven by a second drive shaft 46. The first and second shaker assemblies 40, 44 partially define the picking pathway 20 therebetween. In particular, the first and second shaker assemblies 40, 44 define the harvesting zone 24 of the picking pathway 20. Each of the first and second shaker assemblies 40, 44 for the harvesting mechanism 10 includes a plurality of vertically-aligned sub-assemblies 48. These sub-assemblies 48 are configured to rotate about a respective drive shaft 22 of the first and second drive shafts 42, 46. Accordingly, each of the first and second drive shafts 42, 46 includes a corresponding number of sub-assemblies 48 that are vertically aligned about a rotational axis 50 of each respective drive shaft 22. The first and second shaker assemblies 40, 44 are set on a framework that is operable to manipulate the first and second shaker assemblies 40, 44 relative to the picking pathway 20. In this manner, the first and second shaker assemblies 40, 44 can be moved toward and away from one another to manipulate the harvesting zone 24 to accommodate a variety of types of vegetation 14.

Each of the sub-assemblies 48 of the harvesting mechanism 10 includes a frame 60 that rotates about the respective drive shaft 22. Positioned at an interior portion 62 of each of these frames 60 is a sliding interface 64 that allows the drive shaft 22 to rotate independently of the frame 60 for each sub-assembly 48. The sliding interface 64 of each frame 60 can include, but is not limited to, a bearing assembly, lubricants, and other similar friction-reducing mechanisms and materials that allow the frame 60 to rotate relative to each drive shaft 22. Due to the speed at which the drive shafts 22 rotate, as described herein, and the limited amount of friction that is experienced by the frame 60 via the sliding interface 64, the frame 60 is manipulated relative to the drive shaft 22 to rotate about the rotational axis 50 of the drive shaft 22. As described more fully herein, the frame 60 for each sub-assembly 48 can be slowed with respect to the drive shaft 22. Accordingly, while the drive shaft 22 can be maintained at a particular rotational speed, the rotational speed of the frames 60 can be adjusted to rotate at a range of rotational speeds relative to the drive shaft 22.

Within each sub-assembly 48 is a counterweight assembly 80 that includes pairs of counterweights 82 that are operably coupled to a corresponding drive shaft 22 of the first and second drive shafts 42, 46. Rotational operation of the counterweight assembly 80 produces a vibrating frequency 84 that causes a particular frequency of an eccentric shaking action with respect to each sub-assembly 48 of the first and second shaker assemblies 40, 44 of the harvesting mechanism 10. The counterweight assembly 80 is attached to each corresponding drive shaft 22 via a linkage 86 to minimize slippage. Accordingly, rotation of the counterweight assembly 80 is consistent with the rotational operation of the drive shaft 22. As the rotational speed of the drive shaft 22 increases or decreases, the rotational operation of the counterweight assembly 80, similarly, increases or decreases to match the operation of the corresponding drive shaft 22.

As exemplified in FIGS. 1-13, during operation of the drive shaft 22, the counterweight assembly 80 operates at a consistent rotational speed that matches the operation of the drive shaft 22. This produces the consistent vibrating frequency 84 that can be experienced through one or both of the first and second shaker assemblies 40, 44 of the harvesting mechanism 10. Contemporaneously, the frame 60 for each sub-assembly 48 operates with respect to the drive shaft 22 through the interaction of the frame 60 and the drive shaft 22 at a sliding interface 64. The sliding interface 64 produces a diminished rotational operation of the frame 60 with respect to the drive shaft 22. Additionally, a speed-regulating mechanism 102 is coupled with each frame 60 to selectively slow operation of the frame 60 with respect to the drive shaft 22. Accordingly, while both the frame 60 of the sub-assembly 48 and the counterweight assembly 80 of the sub-assembly 48 are coupled with the drive shaft 22, each of the frame 60 and the counterweight assembly 80 are configured to operate at different relative speeds with respect to the drive shaft 22, as described herein.

Referring again to FIGS. 1-13, within each sub-assembly 48, the frame 60 is configured to rotate in a generally free manner with respect to the first and second drive shafts 42, 46. In addition, each frame 60 includes the counterweight assembly 80 that includes at least one counterweight 82, and typically a plurality of counterweights 82, that are attached to the respective first or second drive shaft 42, 46 via the linkage 86. This linkage 86 maintains a consistent rotational engagement between the counterweights 82 of the counterweight assembly 80 and the drive shaft 22. The linkage 86 that extends between the counterweights 82 and the drive shaft 22 can be in the form of a belt, chain, gear train, and other similar linkage 86. The linkage 86 is used to prevent slippage within the counterweight assembly 80. In this manner, the timing of the rotational motion of the counterweights 82 is maintained to be in unison, or substantially in unison. This unity of movement and unity of timing of the rotation of the counterweights 82 for the counterweight assemblies 80, collectively, are used to produce the controllable and adjustable characteristics of the consistent vibrating frequency 84.

As discussed herein, as the first and second drive shafts 42, 46 rotate at a particular rotational speed, the counterweights 82 for each frame 60 rotate at a proportional speed with respect to the drive shaft 22. This proportional speed can be a 1:1 ratio such that the counterweights 82 for the counterweight assembly 80 rotate at the same rotational speed as the drive shaft 22. It is also contemplated that various gear reduction or gear increasing mechanisms can be incorporated within the linkage 86 to allow the counterweights 82 to rotate faster or slower, in a proportional sense, relative to the rotational speed of the first and second drive shafts 42, 46, respectively. Typically, the interaction between the drive shafts 42, 46 and the counterweight assembly 80 will result in the counterweight assembly 80 rotating at a faster rotational rate than the corresponding drive shaft 42, 46.

Referring again to FIGS. 1-13, within each frame 60 for the various sub-assemblies 48, a plurality of shaker rods 30 are fixedly attached to the frame 60 and extend outwardly from the frame 60. As the frame 60 rotates about the respective drive shaft 22 of the first and second drive shafts 42, 46, the shaker rods 30 rotate through the harvesting zone 24 of the picking pathway 20 that is defined by the berry harvesting assembly 12. Additionally, each frame 60 is selectively operable to be slowed using the speed-regulating mechanism 102, such as a tensioning mechanism, for increasing the friction experienced by the frame 60. Accordingly, an increased tension that is applied by the speed-regulating mechanism 102 results in an increased frictional engagement with the frame 60. This frictional engagement results in the frame 60 rotating at a slower rate of speed around the rotational axis 50 and through the harvesting zone 24.

Each frame 60 also includes the opposing counterweights 82, and typically the opposing pair of counterweights 82, that are attached to the drive shaft 22 via the linkage 86. Using this linkage 86, the pair of opposing counterweights 82 rotate at a consistent rate of speed with respect to the drive shaft 22. In this manner, the frame 60 and the shaker rods 30 are configured to rotate at a desired rate of speed that is typically slower than the rotational speed of the drive shaft 22. At the same time, the opposing counterweights 82 of the counterweight assembly 80 rotate at a consistent speed that is the same as or directly proportional to the rotational speed of the drive shaft 22. Stated another way, the rotational speed of the pair of opposing counterweights 82 can be different than the rotational speed of the frame 60, where each of the frame 60 and the opposing pair of counterweights 82 are attached to the drive shaft 22. In addition, the rotational speed of the frame 60 can be selectively adjusted as the counterweight assembly 80 maintains a consistent rotational rate.

Referring again to FIGS. 1-13, during operation of the opposing pair of counterweights 82, the counterweights 82 include a rotating side 110 that is attached to a drive member 112. Each counterweight 82 also includes a weighted side 114 that is eccentric to a rotating axis 116 of the counterweight 82 that extends through the rotating side 110. In this manner, the counterweights 82 are weighted to one side to provide an eccentric relationship with respect to the rotating axis 116 of each counterweight 82. Accordingly, as each counterweight 82 rotates about the rotating axis 116, an eccentric force is generated that produces the vibrating frequency 84 that extends from each sub-assembly 48 and through the entire shaker assembly 100. Again, each shaker assembly 100 includes the plurality of sub-assemblies 48 for the harvesting mechanism 10. As discussed herein, the timing of the rotation for the various counterweights 82 for the counterweight assemblies 80 is maintained as a consistent timing through the use of the linkages 86 to produce the consistent vibrating frequency 84.

As discussed above, because the counterweight assemblies 80 are attached to the drive shaft 22 and operate at the same speed, or a proportional speed with respect to the drive shaft 22, the entire shaker assembly 100 and all of the counterweights 82 disposed within the shaker assembly 100 operate at the same rotational speed and produce the same consistent vibrating frequency 84. Additionally, each counterweight of the various counterweight assemblies 80 are positioned to operate in unison about the respective rotating axes of the counterweight assemblies 80. Accordingly, each of the pairs of counterweights 82 for all of the sub-assemblies 48 for a particular shaker assembly 100 provide a consistent vibrating frequency 84 throughout the entire shaker assembly 100. This consistent vibrating frequency 84, in turn, allows the shaker rods 30 to vibrate relative to the frames 60 at a consistent vibrating frequency 84. This consistent vibrating frequency 84 is adjustable and can be increased or decreased through an increase or decrease in the rotational speed of the drive shaft 22.

Referring again to FIGS. 1-13, the operation of the harvesting mechanism 10 includes operating the various subassemblies 48 and the counterweight assemblies 80. These contemporaneous actions provide the rotation of the subassemblies 48 and the vibrating frequency 84 of the counterweight assemblies 80. The counterweight assemblies 80 are controlled by the rotational operation of the corresponding drive shaft 42, 46 that is transferred via the linkage 86. The subassemblies 48 are operated through the rotational operation of the respective drive shaft 42, 46, via the sliding interface 64 as well as the frictional engagement of the dedicated speed-regulating mechanism 102.

It is contemplated that the operating speed of the various counterweights 82 of the first and second shaker assemblies 40, 44 can be in the range of from approximately 600 rpm to approximately 1600 rpm. In certain aspects of the device, these rotational frequencies can be in a range of from approximately 900 rpm to approximately 2500 rpm. In certain aspects of the device, these operational frequencies can be in a range of from approximately 900 rpm to approximately 1300 rpm. In certain aspects of the device, the operational frequency of the counterweights 82 can be in a range of from approximately 1600 rpm to approximately 2200 rpm.

According to various aspects of the device, the speed-regulating mechanism 102 that acts on each frame 60, independently, can be in the form of a plurality of speed belts 130, or other similar interface that can apply to certain amounts of tension and friction to the respective frames 60. Each speed belt 130 corresponds to a dedicated frame 60 and operated to apply greater or lesser friction for slowing or speeding up the dedicated frame 60 relative to the drive shaft 22. The speed belt 130 can be configured to selectively apply a tension to a frame 60 for a particular sub-assembly 48. This speed belt 130 is configured to act upon a dedicated sub-assembly 48 without affecting the operation of an adjacent sub-assembly 48. In addition, the increase or decrease of tension that is applied by the speed belt 130 also does not affect the operation of the counterweight assemblies 80, as described herein.

Referring again to FIGS. 1-13, the frame 60 can include a plurality of shaker rods 30 that can include a first set 170 or upper set 140 of shaker rods 30 that are attached to an upper plate 142 of the frame 60 and a second set 172 or lower set 144 of shaker rods 30 that are attached to a lower plate 146 of the frame 60. Between the upper and lower plates 142, 146 of the frame 60, a gasket 148 can be disposed to enclose the interior portion 62 of the frame 60 that include the counterweight assemblies 80 and the sliding interface 64 for that particular frame 60. These gaskets 148 can be in the form of an elastomeric membrane, fabric member, rigid member, combinations thereof, and other similar members that can be attached to the frame 60 for enclosing the interior portion 62 of each frame 60. The use of this gasket 148 is intended to enclose the interior portion 62 of the frames 60 to prevent objects and debris from entering the interior portion 62 defined within each frame 60.

Referring again to FIGS. 1-13, within the picking pathway 20, the berry harvesting assembly 12 can include one or more guide fixtures 160 that generally direct vegetation 14 through the picking pathway 20. In certain aspects of the device, these guide fixtures 160 can be one or more guide tubes 162 or guide structures that are configured to facilitate movement of vegetation 14 through the picking pathway 20. These guide fixtures 160 are also configured to direct the vegetation 14 into the harvesting zone 24 that is generally centrally located between the first and second shaker assemblies 40, 44. This can be used to allow the shaker rods 30 of each of the shaker assemblies to engage the vegetation 14 that passes through the berry harvesting assembly 12.

As exemplified in FIGS. 1-13, the plurality of shaker rods 30 that are included within the first shaker assembly 40 are vertically offset relative to the plurality of shaker rods 30 that are incorporated within the second shaker assembly 44. Using this configuration, the first set 170 of shaker rods 30 for the first shaker assembly 40 can move through a plurality of horizontal planes that extend through the harvesting zone 24 of the berry harvesting assembly 12. The second set 172 of shaker rods 30 for the second shaker assembly 44 move through the harvesting zone 24 along another set of horizontal planes that are vertically offset from the first set 170 of shaker rods 30. Using this configuration, the second set 172 of shaker rods 30 move through the harvesting zone 24 without engaging the first set 170 of shaker rods 30. This configuration allows the first set 170 of shaker rods 30 and the second set 172 of shaker rods 30 to bypass one another in the harvesting zone 24 so that each of the first and second sets 170, 172 of shaker rods 30 can independently engage the vegetation 14 through the harvesting zone 24. Additionally, this configuration of the first and second sets 170, 172 of shaker rods 30 allows the opposing first and second shaker assemblies 40, 44 to cooperatively interact with the vegetation 14 to separate produce 174 from the vegetation 14 without causing inadvertent damage to the harvested produce 174 or the vegetation 14 moving through the picking pathway 20.

Referring again to FIGS. 1-13, the berry harvesting assembly 12 includes the first shaker assembly 40 that is rotatably driven by a first drive shaft 42. A second shaker assembly 44 is rotatably driven by a second drive shaft 46. The first shaker assembly 40 and the second shaker assembly 44 define a processing pathway therebetween. As discussed herein, vegetation 14 moves through the berry harvesting assembly 12 via the processing pathway to be acted upon by the first and second shaker assemblies 40, 44. A plurality of vertically-aligned sub-assemblies 48 are respectively positioned for rotational operation about the first and second drive shafts 42, 46. In this manner, each of the first and second shaker assemblies 40, 44 includes a set of vertically-aligned sub-assemblies 48 that rotatably operate about the first and second drive shafts 42, 46. Each of the sub-assemblies 48 includes a frame 60 that is positioned for rotational operation about a respective drive shaft 22 of the first and second drive shafts 42, 46.

A plurality of harvesting fingers, also referred to as shaker rods 30, extend from the frame 60. As described herein, the harvesting fingers can include an upper set 140 of harvesting fingers 30 that are attached to an upper plate 142 and a lower set 144 of harvesting fingers 30 that are attached to a lower plate 146 of each frame 60. The speed-regulating mechanism 102, which can be in the form of a speed limiter, selectively operates relative to the frame 60 to slow rotation of the frame 60 relative to a rotational speed of the respective drive shaft 22.

As described herein, a sliding interface 64 is disposed between the frame 60 and the respective drive shaft 22. Through this configuration, rotation of the drive shaft 22 generates rotation of the frame 60 through the frictional interaction between the frame 60 and the drive shaft 22. While the sliding interface 64 decreases the friction between the frame 60 of the drive shaft 22, some friction and the high rotational speed of the drive shaft 22 causes the frame 60 to rotate about the drive shaft 22. The speed limiter acts upon the frame 60 to slow the rotation of the frame 60 relative to the drive shaft 22.

Each frame 60 also includes a counterweight assembly 80 that is operably attached to the respective drive shaft 22. This counterweight assembly 80 is rotationally operable according to, or proportional to, the rotational speed of the respective drive shaft 22. Accordingly, while the speed limiter slows the operation of the frame 60, the speed limiter does not have an impact upon the rotational operation of the counterweight assembly 80 relative to the drive shaft 22. The counterweight assembly 80 rotates within the frame 60 to produce a selected vibration frequency that is consistent or proportional with the rotational speed of the respective drive shaft 22. Through this configuration, operation of the counterweight assembly 80 from each frame 60 produces a consistent and selected vibration frequency that occurs throughout the entire shaker assembly 100.

As described herein, each of the counterweight assemblies 80 of the various frames 60 for the vertically-aligned sub-assemblies 48 operate at the same rotational speed to produce a consistent vibration frequency throughout the entire shaker assembly 100. Contemporaneously, each of the sub-assemblies 48 includes a dedicated speed-regulating mechanism 102 that can be independently adjusted to produce a range of rotational speeds for each sub-assembly 48 within the shaker assembly 100. Accordingly, the bottom sub-assembly 48 can be adjusted through the speed-regulating mechanism 102 to rotate a first speed that can be different from each of the other sub-assemblies 48 within the shaker assembly 100. Additionally, each sub-assembly 48 within the shaker assembly 100 can be tuned, using a dedicated speed limiter, to rotate at a different speed than each of the other sub-assemblies 48.

The various sub-assemblies 48 and the motors 26 for operating the drive shafts 22 are each controllable via a user interface 210 that can be disposed upon the berry harvesting assembly 12, or can be remotely controlled via a wireless connection. Each of the speed-regulating mechanisms 102 can be independently controlled through an actuator 132 that increases or decreases the tension of the speed-regulating mechanism 102 relative to each sub-assembly 48. Additionally, the operation of the motor 26 can also be increased or decreased to vary the rotation of the drive shaft 22. Changing the rotational speed of the drive shaft 22, in turn, changes the rotational speed of the plurality of counterweight assemblies 80 within a particular shaker assembly 100. In turn, this change in the motor 26 also changes the vibrating frequency 84 of one or both of the shaker assemblies.

It is contemplated that adjusting the rotational speed of the counterweight assemblies 80 and adjusting the rotational speed of each sub-assembly 48 can be tuned according to various factors and considerations. Such factors and considerations can include, but are not limited to, the type of produce 174 being harvested, the type of vegetation 14 moving through the picking pathway 20, the age of the vegetation 14, whether the harvest is the first harvest of the year or a subsequent harvest, the size of the trunk and branches of the vegetation 14, combinations thereof, and other similar factors.

By way of example, and not limitation, a certain type of blueberry bush may require a particular vibrating frequency 84 to be utilized by the counterweight assembly 80. Also, depending upon the height of the particular sub-assembly 48, each sub-assembly 48 may require a different rotational speed such that the various speed limiters need to be independently tuned based upon the relative height with respect to the blueberry bush. During harvesting, rough impact to the blueberry bushes can cause lateral branches to break and negatively affect the health of the bush and, therefore, the capacity of the bush to grow future berries 32. To address this concern, the sub-assemblies 48 are independently adjustable to vary the rotational speed and, in turn, the amount of force that may be exerted on different sections of the blueberry bush or other vegetation 14. In this manner, the sub-assembly 48 that is positioned near the trunk of the vegetation 14 may move at a slower rate of speed than a sub-assembly 48 that is positioned near a top portion of the vegetation 14 where the branches may be more flexible and more produce 174 may be present.

These various tensions of the speed-regulating mechanism 102 and rotational speeds of the drive shaft 22 can be adjusted during operation of the berry harvesting assembly 12 as the vegetation 14 is moving through the picking pathway 20. Various visual or auditory indications may be perceived by an operator of the berry harvesting assembly 12. These indicators may provide information regarding adjustments that may need to be made to one or more sub-assemblies 48 or the vibrational frequency of the shaker assembly 100. The control panel can include various analog switches, on/off switches, touch screens, dials, levers, combinations thereof, and other similar user interface 210 mechanisms that allow for operation of the harvesting mechanism 10 and the individual components thereof.

Referring again to FIGS. 1-13, the harvesting mechanism 10 for the berry harvesting assembly 12 includes the first shaker assembly 40 that rotationally operates about a first rotational axis 190, a second shaker assembly 44 that rotationally operates about a second rotational axis 192. The first and second shaker assemblies 40, 44 define a harvesting zone 24 therebetween. As discussed herein, the harvesting zone 24 is typically a portion of the picking pathway 20. The drive assembly 28 is attached to the first and second shaker assemblies 40, 44. This drive assembly 28 rotationally operates the first and second shaker assemblies 40, 44 about the respective first and second rotational axes. As described herein, this drive assembly 28 can be in the form of a single motor 26 that operates both the first and second shaker assemblies 40, 44. Additionally, separate and dedicated motors 26 can also be used to operate the first and second shaker assemblies 40, 44.

A plurality of rotating sub-assemblies 48 are rotationally coupled to the drive assembly 28. Each rotating sub-assembly 48 of the plurality of rotating sub-assemblies 48 includes a frame 60 with a sliding interface 64 that is between the structure of the frame 60 and the respective drive shaft 22 that operates about one of the first and second rotational axes. Each frame 60 includes a plurality of harvesting fingers or shaker rods 30 that extend from the frame 60. A speed-regulating mechanism 102 selectively operates to slow a rotational speed of the frame 60 relative to the drive speed of the drive assembly 28. As described herein, each sub-assembly 48 includes a dedicated speed-regulating mechanism 102 that increases the frictional force that is applied to the frame 60. This frictional force serves to slow the rotational operation of the sub-assembly 48 relative to the drive shaft 22.

A pair of counterweights 82 are operably attached to the drive assembly 28 and the frame 60. These pair of counterweights 82 rotationally operate according to the drive speed of the drive assembly 28 and independent of the rotation of the frame 60. The drive assembly 28 and the pair of counterweights 82 operate to produce a selected vibration frequency of the first and second shaker assemblies 40, 44.

According to various aspects of the device, the shaker rods 30 or harvesting fingers can be in the form of rigid rods that extend outward from the frame 60. These rigid shaker rods 30 can be made of metal, plastic, elastomeric material, combinations thereof, and other similar materials. The material of the shaker rods 30 is configured to vibrate according to the operation of the counterweight assemblies 80. Accordingly, the shaker rods 30 are typically manufactured and tuned to produce the desired frequency within the range of frequencies described herein. The shaker rods 30 are configured to engage and manipulate the branches as each sub-assembly 48 rotates through the harvesting zone 24. Additionally, the shaker rods 30 are configured to translate the vibrating frequency 84 from the counterweight assembly 80, through the frame 60 and the shaker rods 30 and into the various branches of the vegetation 14. As discussed herein, this vibrating frequency 84 is then transferred to the various produce 174 that is ripened on the vegetation 14. The desired vibrating frequency 84 for each type of vegetation 14 is configured to weaken the stem of ripened produce 174 so that the ripened produce 174 can be harvested. Also, the desired vibrating frequency 84 is inadequate to weaken the stem of unripe produce 176. In this manner, under-ripened produce 176 is allowed to remain on the vegetation 14 to reach the ripened stage for future harvesting.

During operation of the berry harvesting assembly 12, the berry harvesting assembly 12 can be independently driven or hauled by a separate vehicle to a row of vegetation 14. The berry harvesting assembly 12 is aligned with the row of vegetation 14 and moves along the row of vegetation 14 to cause the vegetation 14 to move through the picking pathway 20 and the harvesting zone 24 of the berry harvesting assembly 12. An operator of the berry harvesting assembly 12 utilizes a user interface 210 to adjust the rotational speed of the drive assembly 28 that operates the first and second drive shafts 42, 46 of the first and second shaker assemblies 40, 44. Additionally, the operator adjusts the individual speed limiters for the various sub-assemblies 48. These various sub-assemblies 48 are tuned or calibrated to interact with a specific vertical portion of the vegetation 14 as it moves through the processing area of the berry harvesting assembly 12. As the vegetation 14 moves through the processing area, the shaker assemblies interact with the vegetation 14 through the rotation of the sub-assemblies 48 as well as the vibration of the shaker assemblies to disengage the produce 174 from the vegetation 14.

The berry harvesting assembly 12 includes a conveyor system 220 that captures the separated produce 174 and moves the produce 174 to a collection area 222 within or on the berry harvesting assembly 12. This conveyor system 220 moves from the harvesting zone 24 and other portion of the picking pathway 20 and to the particular collection area 222 where the produce 174 can be loaded into containers for further processing at a separate location. Additionally, within a lower portion 224 of the processing area, various deflecting panels 226 interact with the trunk of the vegetation 14 to define a catching layer 228 that is positioned above the ground and below the branches of the vegetation 14. These deflecting panels 226 engage the trunk of the vegetation 14 and deflect outward to allow the trunk of the vegetation 14 to pass through the picking pathway 20 and the harvesting zone 24. As the trunk passes each deflecting panel 226, the deflecting panel 226 is biased to an inward position 230 to define a continuous capturing layer that extends across the processing area to capture separated produce 174 that is removed from the vegetation 14.

As exemplified in FIG. 1, the berry harvesting assembly 12 also includes a forward directing portion 240 that includes a generally tapered configuration that tapers inward toward the picking pathway 20. Using this configuration, the vegetation 14 can be directed toward a central portion of the harvesting zone 24. Additionally, the berry harvesting assembly 12 can be continuously aligned to move along the row of vegetation 14 for ensuring that the vegetation 14 moves through a central portion of the harvesting zone 24.

Referring again to FIGS. 1-13, each of the frames 60 include an upper plate 142 and a lower plate 146. The shaker rods 30 or harvesting fingers extend from each of the upper and lower plates 142, 146 to define an upper set 140 of shaker rods 30 and a lower set 144 of shaker rods 30 within each frame 60. Additionally, the counterweight assembly 80 includes the opposing counterweights 82 that rotate about respective rotating axes within the frame 60. Each counterweight 82 of the pair of opposing counterweights 82 includes a drive member 112 that extends between the upper and lower plates 142, 146 for each frame 60. Using the drive member 112, the counterweights 82 of the counterweight assembly 80 are allowed to freely rotate relative to the upper and lower plates 142, 146 of the frame 60. In this manner, the linkage 86 that extends between the drive member 112 for the counterweights 82 and the drive shaft 22 can act upon each of the opposing pair of counterweights 82 to produce the desired vibration frequency. Because the drive member 112 is allowed to freely rotate relative to the upper and lower plates 142, 146 of the frame 60, the speed of the frame 60 can vary depending upon the operation of the speed limiter without affecting the rotational operation of the counterweight assemblies 80.

To ensure smooth operation of the counterweight assemblies 80, the sliding interface 64 and the other components of each sub-assembly 48, various lubricants can be directed into portions of the frame 60 to ensure smooth operation of the components of the sub-assembly 48. Additionally, as described herein, each sub-assembly 48 can include a gasket 148 that covers and conceals the inner workings of the sub-assembly 48, as described herein. In this manner, during operation of the berry harvesting assembly 12, debris and other particles that may be dislodged and moved throughout the harvesting zone 24 are prevented from entering into the interior portion 62 of each frame 60 where the inner working components, such as the drive member 112 for the counterweights 82, the linkage 86 for the counterweights 82, the sliding interface 64 of each frame 60, and other components operate.

According to various aspects of the device, the harvesting mechanism 10 for the berry harvesting assembly 12 operates to produce, contemporaneously, rotational operation and a vibrating operation of the harvesting mechanism 10. As described herein, the rotating motion is produced by each sub-assembly 48 that operates about a drive shaft 22 through the interaction of the frame 60 and the drive shaft 22 via a sliding interface 64. This rotational operation of each of the sub-assemblies 48 can be tuned and calibrated to be different for each vertical section of the vegetation 14. Additionally, the vibrating function of the harvesting mechanism 10 can be defined as a consistent vibrating frequency 84 that acts upon each of the sub-assemblies 48 regardless of the relative speed or changes in speed of the various sub-assemblies 48.

It is also contemplated that the rotational speeds of each of the sub-assemblies 48, as well as the vibrating frequency 84 can be modified during operation of the berry harvesting assembly 12. Through this configuration, the berry harvesting assembly 12 and the shaker assemblies defined therein can be adjusted and tuned to accommodate a wide range of varieties of vegetation 14 and characteristics of the vegetation 14 that produce 174 is being harvested from. Using this variability of the berry harvesting assembly 12, larger percentages of ripe produce 174 can be separated from the vegetation 14 while leaving unripe portions of the berries 32 unharvested to further mature until a later harvesting operation.

Additionally, the variability of the components of the berry harvesting assembly 12 provide for a minimum of damage caused to the vegetation 14 during each harvesting operation. The combination of the vibrating frequency 84 that is delivered to the vegetation 14 through the shaker rods 30 as well as the rotating operation of each of the sub-assemblies 48 causes the stem for ripe berries 32 to weaken to allow ripe berries 32 to separate from the vegetation 14. At the same time, the stems for un-ripened berries 32, which have a higher retaining force, are left unaffected to allow these berries 32 to continue to grow and mature through the harvesting season. Accordingly, using the various components of the berry harvesting assembly 12, greater amounts of ripe produce 174 can be obtained during each harvesting operation and lesser amounts of unripe produce 176 are separated from the vegetation 14 to be later harvested at the appropriate time.

The vibrational frequency of the berry harvesting assembly 12 and the rotational operation sub-assemblies 48 for the berry harvesting assembly 12 are tuned to accommodate each type of vegetation 14 and characteristic of the vegetation 14 moving through the processing area for the berry harvesting assembly 12. Because the berry harvesting assembly 12 can be tuned and calibrated, a finite range of frequencies and rotating speeds can be achieved for maximizing the effectiveness of the various harvesting operations that occur throughout the harvesting season.

Having described various aspects of the berry harvesting assembly 12, a method 400 is disclosed for operating the berry harvesting assembly 12. According to the method 400, the harvesting mechanism 10 for the berry harvesting assembly 12 is activated (step 402). The operator then adjusts the rotational speed of the drive assembly 28 to operate the drive shafts 22 of the shaker assemblies and the sub-assemblies 48 at a starting speed (step 404). The drive assembly 28 is then adjusted, using the user interface 210, to modify the rotational speed of the drive shafts 22 and the vibrating frequency 84 of the counterweight assemblies 80 of the shaker assemblies (step 406). One or more of the speed-regulating mechanisms 102 are individually adjusted to define an independent and desired rotational speed of each sub-assembly (step 408). As discussed herein, adjustment of the speed-regulating mechanisms 102 adjusts the rotational speed of the sub-assemblies 48. However, adjustment of the speed-regulating mechanisms 102 does not affect the vibrating frequency 84. As discussed herein additional adjustment of the drive assembly 28 or any one or more of the speed-regulating mechanisms 102 can be made through the user interface 210 at any time during a harvesting operation.

According to the various aspects of the device, it is contemplated that drive settings of the drive assembly 28 and friction settings of the speed-regulating mechanisms 102 can be stored within a memory of the user interface 210. In such an aspect of the device, certain preset programs can be selected for automatically adjusting the drive assembly 28 and the speed-limiting mechanisms. Additionally, in certain aspects, certain factors can be entered into the user interface 210. Using these factors, a program can be formulated and recommended to the user of the berry harvesting assembly 12.

The berry harvesting assembly 12 comprises a first shaker assembly 40 rotatably driven by a first drive shaft 42 and a second shaker assembly 44 rotatably driven by a second drive shaft 46, the first shaker assembly 40 and the second shaker assembly 44 defining a picking pathway 20 therebetween. Each shaker assembly 100 comprises a plurality of vertically-aligned sub-assemblies 48. Each sub-assembly 48 of the plurality of vertically-aligned sub-assemblies 48 are configured to rotate about the corresponding one of the first and second drive shafts 42, 46 independently from one another.

The counterweight assembly 80 includes pairs of counterweights 82 operably coupled to the corresponding one of the first and second drive shafts 42, 46 to produce an adjustable vibrating frequency 84 across the plurality of vertically-aligned sub-assemblies 48 independent of a rotational speed of the plurality of vertically-aligned sub-assemblies 48. Each sub-assembly 48 of the plurality of vertically-aligned sub-assemblies 48 comprises a frame 60 configured to retain the pair of counterweights 82 and a plurality of shaker rods 30 that extend radially outward from the frame 60.

A rotational speed of each sub-assembly 48 frame 60 can be independently adjusted without changing the speed of the rotating counterweights 82, thereby producing a consistent vibration of the shaker rods 30. The operating speed of the counterweights is typically within a range of from approximately 900 rpm to approximately 1300 rpm, depending on the desired vibrating frequency 84. Also, the operating speed of the counterweight assembly 80 can typically vary within a range of from approximately 1800 rpm to approximately 2400 rpm, depending on the desired vibrating frequency 84. Each sub-assembly 48 is operably coupled to a speed belt 130 or other speed-regulating mechanism 102. The speed belt 130 is configured to selectively apply tension to a dedicated sub-assembly 48, without substantially affecting, or without affecting in any way, the operation of the counterweights 82 of the counterweight assembly 80. An operating speed of a sub-assembly 48 in rotating about the drive shaft 22 is within a range of from approximately 1 rpm to approximately 40 rpm.

The berry harvesting assembly 12 also comprises a gasket assembly coupled to each frame of the sub-assemblies 48. The gasket assembly is configured to enclose the interior portion 62 of the frames to prevent objects from entering the interior portion 62 of the frames. Each sub-assembly 48 of the berry harvesting assembly 12 also includes an upper set 140 of shaker rods 30 and a lower set 144 of shaker rods 30. A plurality of guide tubes 162 are disposed between sets of shaker rods 30 to facilitate movement of a bush through the picking pathway 20. The shaker rods 30 of the first shaker assembly 40 and the second shaker assembly 44 are vertically offset such that the shaker rods 30 are able to move simultaneously through a common and shared vertical space, in the form of the harvesting zone 24, without contacting one another.

A berry harvesting assembly 12 comprises a first shaker assembly 40 rotatably driven by a first drive shaft 42 and a second shaker assembly 44 rotatably driven by a second drive shaft 46. The first shaker assembly 40 and the second shaker assembly 44 define a processing pathway therebetween. A plurality of vertically-aligned sub-assemblies 48 are respectively positioned for rotational operation about the first and second drive shafts 42, 46. Each sub-assembly 48 of the plurality of vertically-aligned sub-assemblies 48 comprise a frame positioned for rotational operation about a respective drive shaft 22 of the first and second drive shafts 42, 46. A plurality of harvesting fingers extend from the frame. A speed limiter selectively operates relative to the frame to slow a rotation of the frame relative to a rotational speed of the respective drive shaft 22. A counterweight assembly 80 is operably attached to the respective drive shaft 22 and is rotationally operable according to the rotational speed of the respective drive shaft 22. The respective drive shaft 22 and the counterweight assembly 80 operate to produce a selected vibration frequency of the respective shaker assembly 100.

A berry harvesting assembly 12 comprises a first shaker assembly 40 that rotationally operates about a first rotational axis 190 and a second shaker assembly 44 that rotationally operates about a second rotational axis. 192 The first and second shaker assemblies 40, 44 define a processing zone therebetween. A drive assembly 28 rotationally operates the first and second shaker assemblies 40, 44 about the first and second rotational axes, respectively. A plurality of rotating sub-assemblies 48 are rotationally coupled to the drive assembly 28. Each rotating sub-assembly 48 or the plurality of rotating sub-assemblies 48 comprise a frame 60 and a plurality of harvesting fingers that extend from the frame 60. A speed limiter selectively operates to slow a rotation of a dedicated frame 60 relative to a drive speed of the drive assembly 28. A pair of counterweights 82 are operably attached to the drive assembly 28 and rotationally operate according to the drive speed of the drive assembly 28 and independent of the rotation of the frame 60. The drive assembly 28 and the pair of counterweights 82 operate to produce a selected vibrating frequency 84 of the first and second shaker assemblies 40, 44 and the plurality of rotating sub-assemblies 48 attached thereto.

According to the various aspects of the device, the operating parameters for the berry harvesting assembly are determined by multiple factors. One such family of factors is the identity of the bush and the shape/structure of the bush and the produce grown on the bush. Additionally, during operation of the berry harvesting assembly 12, adjustments can be made to these parameters based upon auditory and visual cues, such as how the branches of the vegetation 14 look as the vegetation 14 enters and moves through the harvesting zone 24. It should be understood that other parameters, factors and variables can be used to inform a user about adjustments that may or may not need to be made to the berry harvesting assembly 12 and the components thereof.

The berry harvesting machine disclosed herein treats the vegetation 14 with an appropriate amount of agitation and vibration through the shaker rods 30. Additionally, these parameters are adjustable and can be calibrated during use to accommodate sections of vegetation 14 that may have different characteristics. In connection with the berry harvesting assembly 12, a plurality of catcher pans or deflecting panels 226 can be mounted along a lower portion of the picking pathway 20. These deflecting panels 226 extend toward the center of the picking pathway 20 and substantially cover the bottom of the picking pathway 20 to catch separated produce and keep this produce from falling to the ground.

Vertically spaced/stacked heads allow for customization of operating parameters. Additionally, the brakes or other speed-regulating mechanisms 102 independently adjust the operation of the sub-assemblies 48.

The berry harvesting assembly 12 can operate at various speeds along a row of vegetation 14. Such speeds can include ranges of from approximately 1 mph to approximately 5 mph.

The sub-assemblies 48, because they are able to rotate generally freely about the drive shaft 22, provide a certain amount of impact absorption. Engagement of the shaker rods 30 with the vegetation 14 can provide additional resistance that may slow the rotational speed of the sub-assembly 48. Again, this is without affecting the vibrating frequency 84 of the counterweight assembly 80. The brakes or other speed-regulating mechanisms 102 also allow a user to calibrate the pressure and force that may be applied to the vegetation 14 and between portions of the vegetation 14 as described herein.

It is contemplated that soft intermediate catch frames are suspended above the deflecting panels 226 of the catcher plates and conveyor belts.

The user interface 210 can include 12 switches and other controls that operate one or more actuators 132 that can be accessed from a driver's seat or through a wireless interface. The speed of the vibrating frequency 84 can be in a range of from 600 oscillations per minute to approximately 2500 oscillations per minute. Vibrating frequencies used during harvest can be higher than are typically used in conventional harvesting mechanisms 10 due the configuration of the frames 60 and the shaker rods 30 with respect to the drive shaft 22. This provides a greater efficiency of harvesting only ripened produce. The vibrating frequency 84 can be calibrated by a variety of modifications. Typically, the vibration is performed through an amplitude of approximately pprox. ¾″ of time travel. Greater and lesser amounts of time movement are also contemplated for use in certain varieties of vegetation 14.

The linkage 86 that extends between the drive shaft 22 and the counterweight assembly 80 can include one or more pulleys. These pulleys can include reduction or increase ratios that can increase the rate of speed of the counterweight assemblies 80. These ratios can include ranges from approximately 1.1 to approximately 2.0. In certain aspects of the device the counterweight assembly 80 will operate at 1.67 times the rotational speed of the drive shaft 22 through use of the increase mechanism. Using this increase mechanism the counterweight assembly 80 can operate at a rotational rate of from approximately 1600 rpm to approximately 2200 rpm. While increase mechanisms are exemplified, it is contemplated that reduction mechanisms can also be used.

The speed regulating mechanism applies friction to the frames 60 or drums for speed adjustment, while contemporaneously maintaining the rotational speed of the drive shaft 22. It is contemplated that slippage can occur through the sliding interface 64 with the frame 60 or drum. As discussed herein the sliding interface 64 can be bearings or other sliding interface 64 that allows the frame 60 or drum to turn. The frame 60 or drum rotates through the inertia that is translated to the frame 60 from the drive shaft 22 via the sliding interface 64 that occurs in the direction of rotation of the drive shaft 22. The rotation of the frame 60 also occurs, in part, because of the friction that is inherent in the sliding interface 64.

The counterweights 82 are driven by the drive shaft 22 and individual belts or linkages 86 extend to the counterweight assemblies 80. The linkages 86 prevent slippage between the counterweight assemblies 80 and the drive shaft 22 and can operate at a wide range of vibrating frequencies, such as from approximately 600 rpm to approximately 2500 rpm.

The speed-regulating mechanism 102 can be operated by a linear or rotary actuator. Such an actuator can be operated by interfaces that can include a wide range of mechanisms, such as a 12V rotary actuator toggle.

Modifications of the disclosure will occur to those skilled in the art and to those who make or use the concepts disclosed herein. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

It will be understood by one having ordinary skill in the art that construction of the described concepts, and other components, is not limited to any specific material. Other exemplary embodiments of the concepts disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise.

What is claimed is:

1. A berry harvesting assembly, comprising:
a first shaker assembly rotatably driven by a first drive shaft and a second shaker assembly rotatably driven by a second drive shaft, the first shaker assembly and the second shaker assembly defining a picking pathway therebetween, where each shaker assembly comprises:
a plurality of vertically-aligned sub-assemblies, each sub-assembly of the plurality of vertically-aligned sub-assemblies configured to rotate independently from one another about a respective drive shaft of the first drive shaft and the second drive shaft; and
a counterweight assembly operably coupled to the respective drive shaft to produce an adjustable vibration frequency across the plurality of vertically-aligned sub-assemblies, wherein the adjustable vibration frequency is applied independent of a rotational speed of the plurality of vertically-aligned sub-assemblies.

2. The berry harvesting assembly of claim 1, wherein each sub-assembly of the plurality of vertically-aligned sub-assemblies comprise:
a frame configured to retain a pair of counterweights of the counterweight assembly; and
a plurality of shaker rods extending radially outward from the frame.

3. The berry harvesting assembly of claim 2, wherein the rotational speed of each sub-assembly is independently and selectively adjustable, wherein adjustment of the rotational speed of each sub-assembly is performed independently of an operating speed of the counterweight assembly, wherein the counterweight assembly produces a consistent vibration of the plurality of shaker rods during the adjustment of the rotational speed of each sub-assembly.

4. The berry harvesting assembly of claim 3, wherein the operating speed of the counterweight assembly is within a range of approximately 1800 rpm to approximately 2400 rpm.

5. The berry harvesting assembly of claim 1, further comprising a respective plurality of speed belts that respectively operate the plurality of vertically-aligned sub-assemblies, wherein each speed belt of the respective plurality of speed belts selectively applies tension to adjust the rotational speed of a dedicated sub-assembly of the plurality of vertically-aligned sub-assemblies, wherein the counterweight assembly remains unaffected during operation of the respective plurality of speed belts on the plurality of vertically-aligned sub-assemblies.

6. The berry harvesting assembly of claim 5, wherein an operating speed of each sub-assembly is within a range of approximately 1 rpm to approximately 40 rpm.

7. The berry harvesting assembly of claim 2, further comprising:
a gasket assembly coupled to each frame of the plurality of vertically-aligned sub-assemblies, the gasket assembly configured to enclose an interior portion defined within each frame.

8. The berry harvesting assembly of claim 2, wherein the plurality of shaker rods of each sub-assembly includes an upper set of shaker rods and a lower set of shaker rods.

9. The berry harvesting assembly of claim 2, further comprising:
a plurality of guide tubes disposed between sets of the plurality of shaker rods, the guide tubes configured to facilitate movement of vegetation through the picking pathway.

10. The berry harvesting assembly of claim 2, wherein the plurality of shaker rods include a first set of shaker rods of the first shaker assembly and a second set of shaker rods of the second shaker assembly, wherein the first set of shaker rods are vertically offset from the second set of shaker rods to allow the first set and the second set of shaker rods to contemporaneously pass through the picking pathway.

11. A produce harvesting assembly, comprising:
a first shaker assembly rotatably driven by a first drive shaft and a second shaker assembly rotatably driven by a second drive shaft, the first shaker assembly and the second shaker assembly defining a harvesting pathway therebetween; and
a plurality of vertically-aligned sub-assemblies respectively positioned for rotational operation about the first and second drive shafts, each sub-assembly of the plurality of vertically-aligned sub-assemblies comprising:
a frame positioned for rotational operation about a respective drive shaft of the first and second drive shafts;
a plurality of harvesting fingers that extend from the frame;
a speed limiter that selectively operates relative to the frame to slow a rotation of the frame relative to a rotational speed of the respective drive shaft; and
a counterweight assembly that is operably attached to the respective drive shaft and rotationally operable according to the rotational speed of the respective drive shaft, wherein the respective drive shaft and the counterweight assembly operate to produce a selected vibration frequency of the first and second shaker assemblies.

12. The produce harvesting assembly of claim 11, wherein an operating speed of the counterweight assembly is within a range of approximately 1800 rpm to approximately 2400 rpm.

13. The produce harvesting assembly of claim 11, wherein an operating speed of each sub-assembly is within a range of approximately 1 rpm to approximately 40 rpm.

14. The produce harvesting assembly of claim 11, further comprising:
a gasket assembly coupled to each frame of the plurality of vertically-aligned sub-assemblies, the gasket assembly configured to enclose an interior portion defined within each frame.

15. The produce harvesting assembly of claim 11, wherein the plurality of harvesting fingers of each sub-assembly includes an upper set of harvesting fingers and a lower set of harvesting fingers.

16. The produce harvesting assembly of claim 11, further comprising:
a plurality of guide tubes disposed between the first shaker assembly and the second shaker assembly, the guide tubes configured to facilitate movement of vegetation through the harvesting pathway.

17. A produce harvesting assembly, comprising:
a first shaker assembly that rotationally operates about a first rotational axis;
a second shaker assembly that rotationally operates about a second rotational axis, the first and second shaker assemblies defining a processing area therebetween;
a drive assembly that rotationally operates the first and second shaker assemblies about the first and second rotational axes, respectively; and
a plurality of rotating sub-assemblies that are rotationally coupled to the drive assembly, each rotating sub-assembly of the plurality of rotating sub-assemblies are rotationally operable about the first rotational axis and the second rotational axis, respectively, each rotating sub-assembly comprising:
a frame;
a plurality of harvesting fingers that extend from the frame;
a speed limiter that selectively operates to slow a rotation of the frame relative to a drive speed of the drive assembly; and
a pair of counterweights that are operably attached to the drive assembly and rotationally operate according to the drive speed of the drive assembly and independent of the rotation of the frame, wherein the drive assembly and the pair of counterweights operate to produce a selected vibration frequency.

18. The produce harvesting assembly of claim 17, wherein an operating speed of the pair of counterweights is within a range of approximately 1800 rpm to approximately 2400 rpm.

19. The produce harvesting assembly of claim 17, wherein an operating speed of each rotating sub-assembly is within a range of approximately 1 rpm to approximately 40 rpm.

20. The produce harvesting assembly of claim 17, further comprising:
a gasket assembly coupled to each frame of the plurality of rotating sub-assemblies, the gasket assembly configured to enclose an interior portion defined within each frame.
